(19) United States
(12) Patent Application Publication
(10) Pub. No.: US 2024/0290303 A1
(43) Pub. Date: Aug. 29, 2024

(54) Performance Analysis Method, Performance Analysis System, and Non-Transitory Computer-Readable Storage Medium

(71) Applicant: YAMAHA CORPORATION, Hamamatsu-shi (JP)

(72) Inventor: Yuji MIURA, Hamamatsu-shi (JP)

(21) Appl. No.: 18/656,748

(22) Filed: May 7, 2024

Related U.S. Application Data
(63) Continuation of application No. PCT/JP2022/040473, filed on Oct. 28, 2022.

(30) Foreign Application Priority Data
Nov. 8, 2021 (JP) 2021-181699

(51) Int. Cl. G10G 1/00; G06V 20/40; G11B 27/10

(52) U.S. Cl. CPC G10G 1/00; G06V 20/46; G11B 27/10

(57) ABSTRACT

A performance analysis method is implemented by a computer system and includes obtaining image data generated by imaging a percussion instrument. The performance analysis method also includes analyzing the image data to detect a change in the percussion instrument caused by striking of the percussion instrument. The performance analysis method also includes, based on the detected change, generating performance data indicating the striking of the percussion instrument. The performance analysis method also includes, based on the performance data, generating pulse data indicating a pulse structure.

### CROSS-REFERENCE TO RELATED APPLICATIONS

The present application is a continuation application of International Application No. PCT/JP2022/040473, filed Oct. 28, 2022, which claims priority to Japanese Patent Application No. 2021-181699, filed Nov. 8, 2021. The contents of these applications are incorporated herein by reference in their entirety.

### BACKGROUND

The present disclosure relates to a performance analysis method, a performance analysis system, and a non-transitory computer-readable storage medium.

Various technologies and/or techniques have been suggested for processing image data of the act of playing a musical instrument. For example, JP2017-44765A discloses synchronizing image data with sound data indicating the act of playing a musical instrument. When the image data and the sound data are synchronized, reference information such as a time code is used.

In the technique recited in JP2017-44765A, it is necessary to generate the reference information independently of the image data. In actual situations, however, it is difficult to generate highly accurate reference information that serves as a chronological basis for image data. While the example in the foregoing description is regarding synchronization of image data and sound data, the above challenge is anticipated across various aspects of processing image data on the time axis. With the above and other circumstances into consideration, it is an object of an embodiment to generate, based on image data, data that serves as a chronological (temporal) reference for striking of a percussion instrument.

### SUMMARY

One aspect is a performance analysis method implemented by a computer system. The performance analysis method includes obtaining image data generated by imaging a percussion instrument. The performance analysis method also includes analyzing the image data to detect a change in the percussion instrument caused by striking of the percussion instrument. The performance analysis method also includes, based on the detected change, generating performance data indicating the striking of the percussion instrument. The performance analysis method also includes, based on the performance data, generating pulse data indicating a pulse structure.

Another aspect is a performance analysis method implemented by a computer system. The performance analysis method includes obtaining image data generated by imaging a percussion instrument. The method also includes processing the image data to generate performance data indicating striking of the percussion instrument. The method also includes, based on the performance data, generating pulse data indicating a pulse structure.

Another aspect is a performance analysis method implemented by a computer system. The performance analysis method includes obtaining image data generated by imaging a percussion instrument. The method also includes processing the image data to generate pulse data indicating a pulse structure.

Another aspect is a performance analysis system that includes an image data obtainer, an analysis processor, a performance data generator, and a pulse data generator. The image data obtainer is configured to obtain image data generated by imaging a percussion instrument. The analysis processor is configured to analyze the image data to detect a change in the percussion instrument caused by striking of the percussion instrument. The performance data generator is configured to generate, based on the detected change, performance data indicating the striking of the percussion instrument. The pulse data generator is configured to generate, based on the performance data, pulse data indicating a pulse structure.

Another aspect is a non-transitory computer-readable storage medium storing a program. When the program is executed by a computer system, the program causes the computer system to obtain image data generated by imaging a percussion instrument. The program also causes the computer system to analyze the image data to detect a change in the percussion instrument caused by striking of the percussion instrument. The program also causes the computer system to generate, based on the detected change, performance data indicating the striking of the percussion instrument. The program also causes the computer system to generate, based on the performance data, pulse data indicating a pulse structure.

A more complete appreciation of the present disclosure and many of the attendant advantages thereof will be readily obtained as the same becomes better understood by reference to the following detailed description when considered in connection with the following figures, in which:

### BRIEF DESCRIPTION OF THE DRAWINGS

FIG. 1 is a block diagram of an example configuration of an information processing system according to an embodiment;

FIG. 2 is a block diagram of an example configuration of a performance analysis system;

FIG. 3 is a block diagram of an example functional configuration of a performance analysis system;

FIG. 4 is a flowchart of an example detail procedure for performance detection processing;

FIG. 5 is a schematic illustration of processings performed by an analysis processor and a performance data generator;

FIG. 6 is a flowchart of an example detail procedure for synchronization control processing;

FIG. 7 is a flowchart of an example detail procedure for performance analysis processing;

FIG. 8 is a flowchart of an example detail procedure for performance detection processing according to an embodiment;

FIG. 9 is a block diagram of an example functional configuration of a performance analysis system according to an embodiment;

FIG. 10 is a flowchart of an example detail procedure for synchronization control processing according to the embodiment;

FIG. 11 is a flowchart of an example detail procedure for performance analysis processing according to the third previous embodiment;

FIG. 12 is a block diagram of an example functional configuration of a performance analysis system according to an embodiment;

FIG. 13 is a flowchart of an example detail procedure for performance analysis processing according to the embodiment;

FIG. 14 is a block diagram of an example functional configuration of a performance analysis system according to an embodiment;

FIG. 15 is a flowchart of an example detail procedure for synchronization adjustment processing according to the embodiment;

FIG. 16 is a flowchart of an example detail procedure for performance analysis processing according to the embodiment;

FIG. 17 is a schematic illustration of a trained model according to an embodiment;

FIG. 18 is a block diagram of an example functional configuration of a performance analysis system according to a modification; and

FIG. 19 is a block diagram of an example functional configuration of a performance analysis system according to the modification.

### DETAILED DESCRIPTION OF THE EMBODIMENTS

The present specification is applicable to a performance analysis method, a performance analysis system, and a non-transitory computer-readable storage medium.

The embodiments will now be described with reference to the accompanying drawings, wherein like reference numerals designate corresponding or identical elements throughout the various drawings. The embodiments presented below serve as illustrative examples of the present disclosure and are not intended to limit the scope of the present disclosure.

In this specification, the term “image” is intended to encompass a still image, a sequence of still images, multiple still images spaced throughout time, or images in the form of a video.

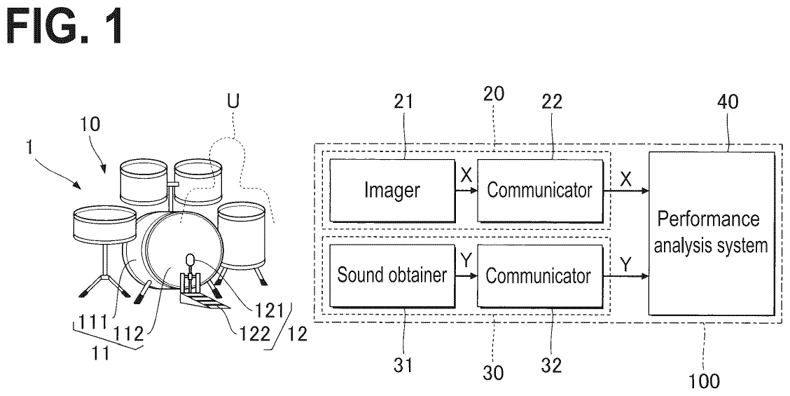

FIG. 1 is a block diagram of an example configuration of an information processing system 100 according to an embodiment. The information processing system 100 is a computer system that records and analyzes a performance of a user U by striking a percussion instrument 1.

The percussion instrument 1 includes a drum set 10 and a foot pedal 12. The drum set 10 includes a plurality of drums including a bass drum 11. The bass drum 11 is a percussion instrument including a body 111 and a head 112. The body 111 is a cylindrical structure (shell). The head 112 is a planar elastic member that seals an opening of the body 111. Another opening of the body 111 opposite to the head 112 is sealed by a bottom head, which is not illustrated in FIG. 1. The user U uses the foot pedal 12 to strike the head 112 to play the percussion instrument's part in a musical piece. It is to be noted that the head 112 may be a mesh head, which is used to eliminate or minimize sound. That is, the opening of the body 111 may not necessarily be completely sealed.

The foot pedal 12 includes a beater 121 and a pedal 122. The beater 121 is a striking body to strike the bass drum 11. The pedal 122 receives the user U's pressing. The beater 121 strikes the head 112 in coordination with the user U's pressing of the pedal 122. The head 112 is caused to vibrate by being struck by the beater 121. Thus, the head 112 is a vibration body that vibrates by the user U's striking. The drum set 10 may not necessarily be played by the user U. For example, the drum set 10 may be played by a performance robot capable of automatic performance of a musical piece.

The information processing system 100 includes a recorder 20, a recorder 30, and a performance analysis system 40. The performance analysis system 40 a computer system that analyzes a performance of the user U striking the percussion instrument 1. The performance analysis system 40 communicates with the recorder 20 and the recorder 30. The communication between the performance analysis system 40 and the recorder 20 and the communication between the performance analysis system 40 and the recorder 30 are near-field wireless communication such as by Wi-Fi (registered trademark) or Bluetooth (registered trademark). It is to be noted, however, that the performance analysis system 40 may have wired communication between the recorder 20 or the recorder 30. Also, the performance analysis system 40 may be implemented by a server device that communicates with the recorder 20 and the recorder 30 via a communication network such as the Internet.

Each of the recorder 20 and the recorder 30 records a performance of the user U playing the drum set 10. The recorder 20 and the recorder 30 are installed at different positions and angles relative to the drum set 10.

The recorder 20 includes an imager 21 and a communicator 22. The imager 21 generates image data X by imaging the user U playing (striking) the percussion instrument 1. Specifically, the image data X is generated based on an obtained image of the percussion instrument 1. The imaging range of the imager 21 encompasses the head 112 of the bass drum 11. Thus, the image indicated by the image data X includes the head 112. The imager 21 includes, for example, an optical system, an imaging element, and a processing circuit. An example of the optical system is a photographic lens. The imaging element receives light from the optical system. The processing circuit generates image data X that is based on the amount of the light received by the imaging element. The imager 21 starts and ends the recording at an instruction from the user U. Specifically, the imaging performed by the imager 21 is started and ended at an instruction from the user U. It is to be noted that the image indicated by the image data X may include only a part of the bass drum 11, another drum of the drum set 10 than the bass drum 11, or a musical instrument other than the drum set 10. It is also to be noted that an other user than the user U may instruct the imager 21 to start or end the recording.

The communicator 22 transmits the image data X to the performance analysis system 40. For example, an information device such as a smartphone, a tablet terminal, and a personal computer is used as the recorder 20. It is to be noted, however, that a video camera or another recording dedicated device may be used as the recorder 20. It is also to be noted that the imager 21 and the communicator 22 may be devices separate from each other.

The recorder 30 includes a sound obtainer 31 and a communicator 32. The sound obtainer 31 obtains sound of the environment surrounding the recorder 30. Specifically, the sound obtainer 31 generates sound data Y by obtaining performance sound of the percussion instrument 1 (the drum set 10). The performance sound is sound emitted from the percussion instrument 1 played (struck) by the user U. The sound obtainer 31 includes, for example, a microphone and a processing circuit. The microphone generates a sound signal by obtaining sound. The processing circuit generates sound data Y based on the sound signal. The sound obtainer 31 starts and ends the recording at an instruction from the user U. It is to be noted that an other user than the user U may instruct the sound obtainer 31 to start or end the recording.

The communicator 32 transmits the sound data Y to the performance analysis system 40. For example, an information device such as a smartphone, a tablet terminal, and a personal computer is used as the recorder 30. It is to be noted that a sound instrument such as a microphone itself may be used as the recorder 30. It is also to be noted that the sound obtainer 31 and the communicator 32 may be devices separate from each other.

The imaging performed by the imager 21 and the sound obtaining performed by the sound obtainer 31 are performed simultaneously with the performance of the user U playing the drum set 10. That is, the image data X and the sound data Y are generated in parallel with each other on a common musical piece. The performance analysis system 40 synthesizes the image data X and the sound data Y with each other to generate synthesized data Z. The synthesized data Z is a video including the image indicated by the image data X and the sound indicated by the sound data Y.

Considering the synthesis of the image data X and the sound data Y, the imager 21 and the sound obtainer 31 preferably start the respective recordings simultaneously before the start of the playing of the percussion instrument 1 and end the respective recordings simultaneously after the end of the playing. However, the imager 21 and the sound obtainer 31 are instructed individually to start and end the respective recordings. Therefore, the time point at which the imager 21 starts its recording is different from the time point at which the sound obtainer 31 starts its recording. Likewise, the time point at which the imager 21 ends its recording is different from the time point at which the sound obtainer 31 ends its recording That is, the image indicated by the image data X and the performance sound indicated by the sound data Y may differ from each other in position on the time axis. Under the circumstances, the performance analysis system 40 synchronizes the image data X and the sound data Y with each other on the time axis.

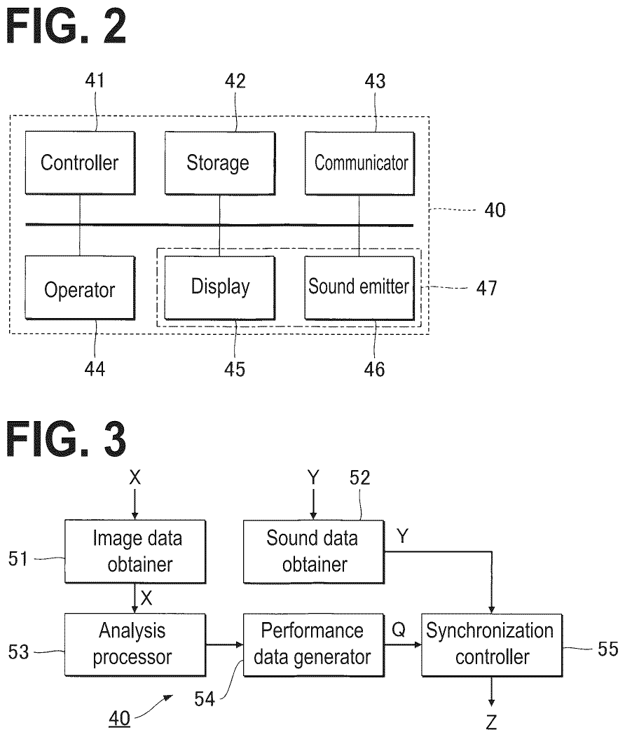

FIG. 2 is a block diagram of an example configuration of the performance analysis system 40. The performance analysis system 40 includes a controller 41, a storage 42, a communicator 43, an operator 44, a display 45, and a sound emitter 46. It is to be noted that while the performance analysis system 40 is a single apparatus, the performance analysis system 40 may be implemented by a plurality of apparatuses separate from each other. It is to also be noted that the recorder 20 or the recorder 30 may be incorporated in the performance analysis system 40.

The controller 41 is implemented by a single processor or a plurality of processors to control the elements of the performance analysis system 40. For example, the controller 41 is implemented by one kind of processor or more than one kind of processor such as CPU (Central Processing Unit), GPU (Graphics Processing Unit), SPU (Sound Processing Unit), DSP (Digital Signal Processor), FPGA (Field Programmable Gate Array), and ASIC (Application Specific Integrated Circuit).

The communicator 43 communicates with the recorder 20 and the recorder 30. Specifically, the communicator 43 receives the image data X transmitted from the recorder 20 and the sound data Y transmitted from the recorder 30.

The storage 42 is implemented by a single memory or a plurality of memories to store: programs executed by the controller 41; and various pieces of data used by the controller 41. For example, the image data X and the sound data Y received by the communicator 43 are stored in the storage 42. The storage 42 can be implemented by a known storage medium such as a magnetic storage medium or a semiconductor storage medium, or can be implemented by a combination of: a plurality of kinds of storage mediums. It is to be noted that a portable storage medium attachable and detachable to and from the performance analysis system 40 may be used as the storage 42. Another example of the storage 42 is a storage medium (for example, a cloud storage) that can be subjected to writing and/or reading by the controller 41 via a communication network such as the Internet.

The operator 44 is an input device that receives an instruction from the user U. Examples of the operator 44 include an operation piece operated by the user U and a touch panel that detects a contact by the user U. It is to be noted that a operator 44 (such as a mouse or a keyboard) separate from the performance analysis system 40 may be connected to the performance analysis system 40 via a wire or wirelessly. It is also to be noted that an other user than the user U, who plays the percussion instrument 1, may operate the operator 44.

The display 45 displays various images under the control of the controller 41. For example, the display 45 displays the image indicated by the image data X of the synthesized data Z. Examples of the display 45 include various display panels such as a liquid-crystal display panel and an organic EL (Electroluminescence) panel. It is to be noted that a display 45 separate from the performance analysis system 40 may be connected to the performance analysis system 40 via a wire or wirelessly.

The sound emitter 46 reproduces the sound indicated by the sound data Y of the synthesized data Z. The sound emitter 46 can be a speaker or a headphone. It is to be noted that a sound emitter 46 separate from the performance analysis system 40 may be connected to the performance analysis system 40 via a wire or wirelessly. As can be understood from the foregoing description, the display 45 and the sound emitter 46 serve as a reproducer 47. The reproducer 47 reproduces the synthesized data Z.

FIG. 3 is a block diagram of an example functional configuration of the performance analysis system 40. The controller 41 executes a program stored in the storage 42 to implement a plurality of functions to generate the synthesized data Z. The plurality of functions include an image data obtainer 51, a sound data obtainer 52, an analysis processor 53, a performance data generator 54, and a synchronization controller 55.

The image data obtainer 51 obtains the image data X. Specifically, the image data obtainer 51 receives, at the communicator 43, the image data X transmitted from the recorder 20. The sound data obtainer 52 obtains the sound data Y Specifically, the sound data obtainer 52 receives, at the communicator 43, the sound data Y transmitted from the recorder 30.

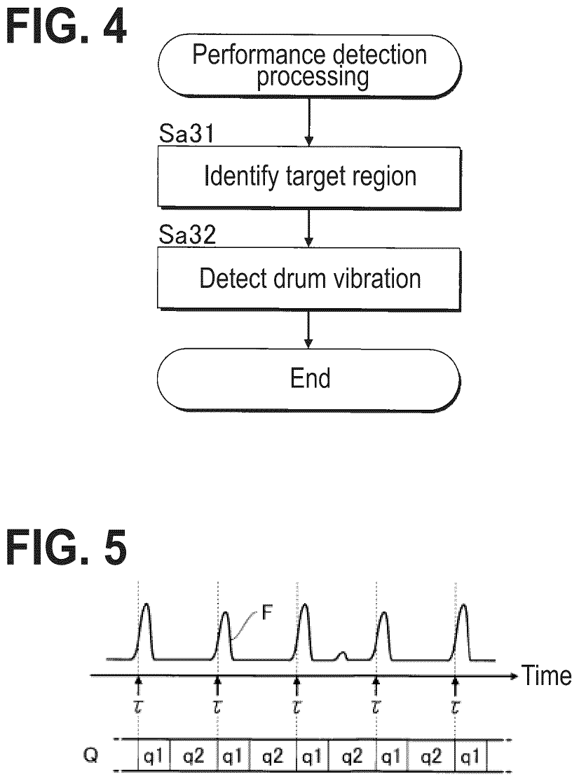

The analysis processor 53 analyzes the image data X to detect a vibration of the bass drum 11 caused by striking of the bass drum 11. Specifically, the analysis processor 53 detects a vibration of the head 112 of the bass drum 11. FIG. 4 is a flowchart of an example detail procedure for the analysis processor 53's processing of detecting a vibration of the bass drum 11 (this processing will be hereinafter referred to as “performance detection processing”).

Upon start of the performance detection processing, the analysis processor 53 analyzes the image indicated by the image data X to identify a region where the bass drum 11 exists (this region will be hereinafter referred to as “target region”) (Sa 31). The target region is a region of the head 112 of the bass drum 11. The target region may also be referred to as a region where the head 112 is caused to vibrate by the striking of the percussion instrument 1. The target region may be identified by any known object-detection processing. For example, the target region may be identified by object-detection processing using a deep neural network (DNN) such as convolutional neural network (CNN).

The analysis processor 53 detects the vibration of the head 112 based on a change in the image showing the target region (Sa 32). Specifically, as exemplified in FIG. 5, the analysis processor 53 calculates a feature quantity F of the image of the target region, and detects a vibration based on a change in time of the feature quantity F. The feature quantity F is an indicator of a feature of the image indicated by the image data X. The feature quantity F may be information indicating an optical property of the image showing the target region. For example, the optical property may be an average tone (brightness) value. The amount of reflection light reaching the imager 21 from the head 112 of the bass drum 11 depends on the vibration of the head 112. The analysis processor 53 detects time point r as a time point at which the head 112 vibrates. The time point r is when the amount of change in the feature quantity F (for example, amount of increase or amount of decrease) exceeds a predetermined threshold. The head 112 of the bass drum 11 vibrates every time the head 112 is struck using the beater 121. The analysis processor 53 sequentially identifies time points r of vibration. Each time point r corresponds to a time point at which the user U strikes the drum set 10 using the beater 121. The amplitude of the vibration of the head 112 depends on the intensity with which the user U strikes the bass drum 11 (hereinafter referred to as “striking intensity”). Therefore, the amount of change in the reflection light reaching the imager 21 from the head 112 of the bass drum 11 depends on the striking intensity. With these relationships taken into consideration, the analysis processor 53 calculates the striking intensity based on the amount of change in the feature quantity F. For example, the analysis processor 53 sets the striking intensity to a higher value for a larger amount of change in the feature quantity F. As described above, the performance detection processing includes: processing of identifying a target region of the bass drum 11 based on the image indicated by the image data X (Sa 31); and processing of detecting a vibration of the head 112 based on a change in an image of the target region (Sa 32). It is to be noted that the feature quantity F will not be limited to the type described above. For example, the analysis processor 53 may analyze the image data X to extract a feature point of the percussion instrument 1, and may calculate a feature quantity F related to a movement of the feature point. In this case, the velocity or acceleration of the movement of the feature point is calculated as a feature quantity F. The feature quantity F exemplified above may be calculated using a known technique such as optical flow. The feature point of the percussion instrument 1 is a characteristic point extracted from the image of the percussion instrument 1 by predetermined image processing on the image data X.

The performance data generator 54 illustrated in FIG. 3 generates performance data Q based on the detection result obtained by the analysis processor 53. The performance data Q indicates a performance of the user U striking the percussion instrument 1. As exemplified in FIG. 5, the performance data Q is time-series data in which emitted sound data q1 and time point data q2 are aligned. The emitted sound data q1 indicates emitted sound of the drum set 10. The time point data q2 specifies the time point of the emission of the sound of the drum set 10. The emitted sound data q1 is event data that specifies the striking intensity detected by the analysis processor 53. The time point data q2 specifies the time point of each sound emission from the drum set 10 based on, for example, the time interval between the previous sound emission and the next sound emission or the time passed from the time point when the striking of the percussion instrument 1 started. The performance data generator 54 generates performance data Q. The performance data Q specifies time points r of vibration detected based on the image data X as a time point of sound emission of the drum set 10 (this time point will be hereinafter referred to as “sound emission point”). The performance data Q is time-series data compliant with MIDI standards, for example.

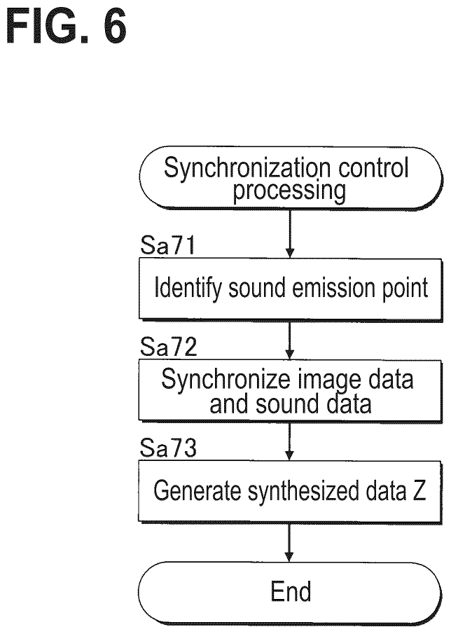

The synchronization controller 55 illustrated in FIG. 3 synchronizes the image data X and the sound data Y with each other using the performance data Q. FIG. 6 is a flowchart of an example detail procedure for the synchronization controller 55's processing of synchronizing the image data X and the sound data Y with each other (this processing will be hereinafter referred to as “synchronization control processing”).

Upon start of the synchronization control processing, the synchronization controller 55 analyzes the sound data Y to identify a sound emission point of the bass drum 11 (Sa 71). For example, there may be time points in the sound data Y at which the amount of increase of the sound volume exceeds a predetermined value. The synchronization controller 55 sequentially identifies these time points as sound emission points. In a case that a sound emission point is identified using the sound data Y, a known beat tracking technique may be employed. It is to be noted that the synchronization control processing may be performed according to any other procedure; for example, beat tracking is not essential.

The synchronization controller 55 synchronizes the image data X and the sound data Y with each other using the performance data Q (Sa 72). Specifically, the synchronization controller 55 determines the position of the sound data Y on the time axis relative to the image data X so that each of the sound emission points specified by the performance data Q aligns on the time axis with a corresponding one of the sound emission points identified from the sound data Y As can be understood from the foregoing description, the synchronization of the image data X and the sound data Y is to adjust the position of one of the image data X and the sound data Y relative to the position of the other on the time axis so that a sound indicated by the sound data Y at an arbitrary time point in a musical piece and an image indicated by the image data X at the arbitrary time point correspond to each other on the time axis. Thus, the processing performed by the synchronization controller 55 can also be expressed as processing of adjusting the chronological synchronization between the image data X and the sound data Y As has been described hereinbefore, the previous embodiment ensures that image data X and sound data Y prepared independently of each other are synchronized with each other.

The synchronization controller 55 generates synthesized data Z, which includes the image data X and the sound data Y synchronized with each other (Sa 73). The synthesized data Z is reproduced by the reproducer 47. As described above, in the synthesized data Z, the image data X and the sound data Y are synchronized with each other. Specifically, when an image indicated by the image data X and showing a particular part of a musical piece is displayed on the display 45 at a particular time point, a performance sound indicated by the sound data Y and corresponding to the particular part is reproduced by the sound emitter 46.

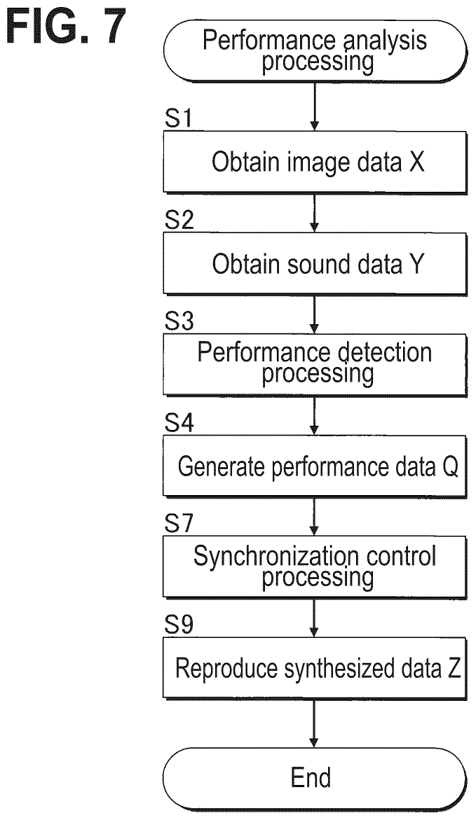

FIG. 7 is a flowchart of an example detail procedure for processing performed by the controller 41′ (this processing will be hereinafter referred to as “performance analysis processing”). For example, the performance analysis processing starts at an instruction from the user U to the operator 44. The performance analysis processing illustrated in FIG. 7 is an example of the “performance analysis method”.

Upon start of the performance analysis processing, the controller 41 serves as the image data obtainer 51 to obtain the image data X (S1). The controller 41 also serves as the sound data obtainer 52 to obtain the sound data Y (S2).

The controller 41 performs the performance detection processing (S3). Specifically, the controller 41 analyzes the image data X to detect a vibration of the drum set 10 (the head 112). That is, the controller 41 serves as the analysis processor 53. The controller 41 generates the performance data Q using the result of the performance detection processing (S4). That is, the controller 41 serves as the performance data generator 54.

The controller 41 performs the synchronization control processing (S7). Specifically, the controller 41 synchronizes the image data X and the sound data Y with each other using the performance data Q to generate the synthesized data Z. That is, the controller 41 serves as the synchronization controller 55. The controller 41 controls the reproducer 47 to reproduce the synthesized data Z (S9).

As has been described hereinbefore, in this embodiment, the image data X, which is generated by imaging the percussion instrument 1, is analyzed to detect a vibration of the bass drum 11 (the head 112). Based on the detected vibration, the performance data Q, which indicates playing of the bass drum 11, is generated. That is, the performance data Q, which serves as a chronological reference related to the playing of the percussion instrument 1, is generated based on the image data X.

It is to be noted that the bass drum 11 is generally played in a fixed state. In contrast, musical instruments other than percussion instruments such as a bow-string musical instrument and a wind instrument (hereinafter referred to as “non-percussion instruments”) move from moment to moment in accordance with the performer's movement or a change in the performer's posture. Specifically, the bass drum 11 tends to remain stationary as compared with non-percussion instruments. This embodiment is also advantageous in that analyzing the image data X of the bass drum 11 reduces the load necessary for generating the performance data Q as compared with a configuration in which performance data is generated by analyzing image data of a non-percussion instrument.

Also in this embodiment, the image indicated by the image data X is analyzed to identify a target region of the bass drum 11. As a result, a vibration of the bass drum 11 is detected more highly accurately than a configuration in which a vibration is detected without identifying a target region. As described above, the bass drum 11 tends to remain stationary as compared with non-percussion instruments. This ensures that the target region where the bass drum 11 exists is identified easily and highly accurately from the image data X. That is, by setting the bass drum 11 as the detection target, the processing load for detecting a vibration is reduced.

An embodiment will be described below. It is to be noted that like reference numerals designate corresponding or identical elements throughout the above and following embodiments, and these elements will not be elaborated upon here.

In the previous embodiment, the imager 21 images the bass drum 11. In this embodiment, the imager 21 images the foot pedal 12, which is used to play the bass drum 11, to generate the image data X. It is to be noted that in this or previous embodiment, the imager 21 may image both the bass drum 11 and the foot pedal 12.

The performance analysis system 40 has a configuration similar to the previous embodiment (FIG. 3). Similarly to the previous embodiment, the controller 41 executes a program stored in the storage 42 to implement a plurality of functions to generate the synthesized data Z. The plurality of functions include the image data obtainer 51, the sound data obtainer 52, the analysis processor 53, the performance data generator 54, and the synchronization controller 55. The image data obtainer 51 obtains the image data X, similarly to the previous embodiment. The sound data obtainer 52 obtains the sound data Y, similarly to the previous embodiment.

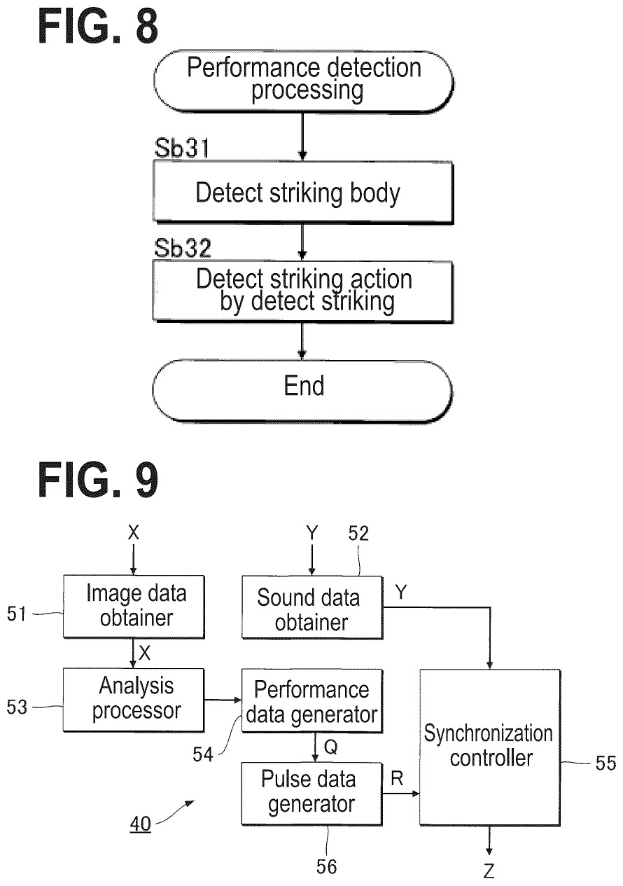

The analysis processor 53 according to the previous embodiment detects a vibration of the bass drum 11 caused by striking of the bass drum 11, as described above. The analysis processor 53 according to this embodiment analyzes the image data X, which is generated by imaging the foot pedal 12, to detect the action of the bass drum 11 being struck by the beater 121 of the foot pedal 12. Specifically, the analysis processor 53 performs the performance detection processing exemplified in FIG. 8 to detect the action of the bass drum 11 being struck by the beater 121. That is, the performance detection processing performed in the previous embodiment as illustrated in FIG. 3 is replaced by the performance detection processing illustrated in FIG. 8 in this embodiment.

Upon start of the performance detection processing, the analysis processor 53 detects the beater 121 from the image indicated by the image data X (Sb 31). The beater 121 may be identified by known object-detection processing. For example, object-detection processing using a deep neural network such as a convolutional neural network may be performed to identify the beater 121.

The analysis processor 53 detects the action of the drum set 10 being struck by the beater 121 based on a change in the position of the beater 121 detected from the image data X (Sb 32). Specifically, when the beater 121 moves in a reverse direction opposite to a predetermined direction, the analysis processor 53 detects the time point of this movement as a time point of striking by the beater 121. The striking intensity as controlled by the user U depends on the movement speed of the beater 121. With this relationship taken into consideration, the analysis processor 53 calculates the striking intensity based on the movement speed of the beater 121 detected based on the image data X. For example, the analysis processor 53 sets the striking intensity to a higher value for a higher movement speed of the beater 121. As has been described hereinbefore, the performance detection processing according to this embodiment includes: the processing of detecting the beater 121 from the image indicated by the image data X (Sb 31); and the processing of detecting striking based on a change in the position of the beater 121 (Sb 32).

Similarly to the previous embodiment, the performance data generator 54 according to this embodiment generates the performance data Q based on the detection result obtained by the analysis processor 53. The performance data Q indicates a performance of the user U striking the percussion instrument 1. Specifically, the performance data generator 54 generates the performance data Q such that the performance data Q specifies the time point of striking detected based on the image data X as the sound emission point of the bass drum 11. Similarly to the previous embodiment, the performance data Q includes emitted sound data q1 and time point data q2. The emitted sound data q1 specifies striking intensity. The time point data q2 specifies the time point of sound emission.

The synchronization controller 55 synchronizes the image data X and the sound data Y with each other using the performance data Q. Specifically, similarly to the previous embodiment, the synchronization controller 55 performs the synchronization control processing (FIG. 6) to synchronize the image data X and the sound data Y with each other.

The performance analysis processing according to this embodiment is similar to the performance analysis processing according to the previous embodiment exemplified in FIG. 7. As described above, however, in this embodiment, the performance detection processing of the performance analysis processing illustrated in FIG. 3 is replaced by the performance detection processing illustrated in FIG. 8.

As has been described hereinbefore, in this embodiment, the image data X is generated by imaging the beater 121 and analyzed to detect the beater 121's striking action. Then, based on the detected striking action, the performance data Q, which indicates playing of the bass drum 11, is generated. That is, the performance data Q serves as a chronological reference for the image data X, and such performance data Q is generated based on the image data X.

FIG. 9 is a block diagram of an example functional configuration of the performance analysis system 40 according to an embodiment. The controller 41 according to this embodiment executes a program stored in the storage 42 to function as a pulse data generator 56, in addition to the elements used in the previous embodiment, namely, the image data obtainer 51, the sound data obtainer 52, the analysis processor 53, the performance data generator 54, and the synchronization controller 55.

The pulse data generator 56 generates pulse data R based on the performance data Q. The pulse data R is data indicating a pulse structure of a musical piece played using the percussion instrument 1. A pulse structure means a structure of a pulse in a musical piece. Specifically, a pulse structure is a rhythm pattern structure (time signature) specified by a combination of a plurality of beats including strong beats and weak beats and the time points at which the beats occur. While a pulse structure is typically repeated in every measure (bar) of a musical piece, repeatability is not essential. The pulse data generator 56 generates the pulse data R by analyzing the performance data Q. Specifically, the pulse data generator 56 classifies strikings specified in chronological order in the performance data Q into strong beats and weak beats. Then, the pulse data generator 56 identifies, as a pulse structure, a periodic pattern made up of strong beats and weak beats. In this manner, the pulse data generator 56 generates the pulse data R. It is to be noted that any known technique may be employed to generate the pulse data R (that is, analyze the pulse structure) using the performance data Q. For example, the pulse structure may be analyzed using techniques described in: Hamanaka et al., “An Automatic Music Analyzing System based on GTTM: Acquisition of Grouping Structures and Metrical Structures”, Information Processing Society Study Report (MUS), Music Information Science 56, 1-8, 2004-08-02; and Goto et al., “A Real-Time Beat Tracking System for Audio Signals. Application to Drumless Music by Detecting Chord Changes.”, the Journal of the Institute of Electronics, Information and Communication Engineers, D-2, Information-System 2: Information Processing 00081 (00002), 227-237, 1998-02-25.

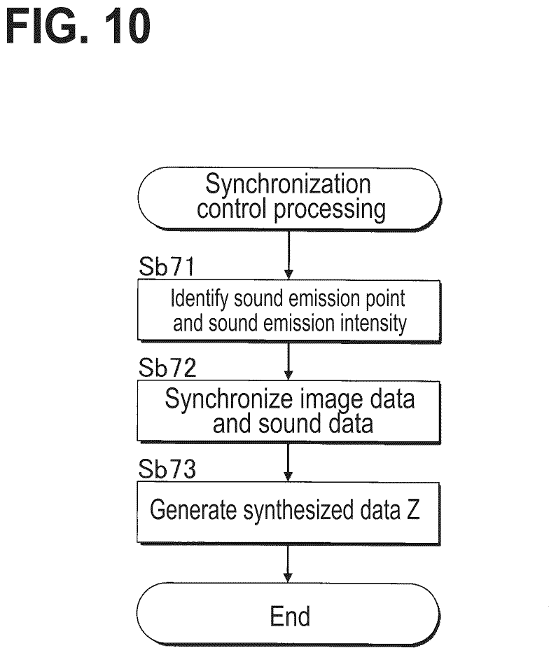

The synchronization controller 55 according to the first previous embodiment synchronizes the image data X and the sound data Y with each other using the performance data Q, as described above. The synchronization controller 55 according to the immediately previous embodiment synchronizes the image data X and the sound data Y with each other using the pulse data R. FIG. 10 is a flowchart of an example detail procedure for synchronization control processing performed by the synchronization controller 55 according to this embodiment. Specifically, the synchronization control processing according to the previous embodiment illustrated in FIG. 6 is replaced by the synchronization control processing illustrated in FIG. 10 in this embodiment.

Upon start of the synchronization control processing, the synchronization controller 55 analyzes the sound data Y to identify sound emission points of the bass drum 11 and sound emission strength (Sb 71). The sound emission strength is the strength of emitted sound which strength is identified from the sound data Y (an example of the sound emission strength is sound volume). For example, there may be a case that the sound data Y includes time points at which the amount of increase of the sound volume exceeds a predetermined value. In this case, the synchronization controller 55 sequentially identifies these time points as sound emission points, and identifies the sound volume at each sound emission point as sound emission strength.

The synchronization controller 55 synchronizes the image data X and the sound data Y with each other using the pulse data R (Sb 72). For example, the synchronization controller 55 identifies, from the sound data Y, a period for which the pattern of the sound emission strength at each sound emission point approximates with the pulse structure specified by the pulse data R. Then, the synchronization controller 55 determines the position of the sound data Y on the time axis relative to the image data X so that the period identified from the sound data Y coincides on the time axis with the section of the image data X which section corresponds to the pulse structure. That is, in controlling the synchronization of the image data X and the sound data Y, not only the sound emission points are aligned simply in a time-series order, but also the pulse structure in a musical piece is taken into consideration.

Similarly to the previous embodiment, the synchronization controller 55 generates the synthesized data Z, which includes the image data X and the sound data Y synchronized with each other (Sb 73). The synthesized data Z is reproduced by the reproducer 47. As described above, in the synthesized data Z, the image data X and the sound data Y are synchronized with each other. Thus, at a time point at which an image included in the image data X which image corresponds to a particular location in a musical piece is being displayed on the display 45, a performance sound included in the sound data Y which performance sound corresponds to the location is reproduced by the sound emitter 46.

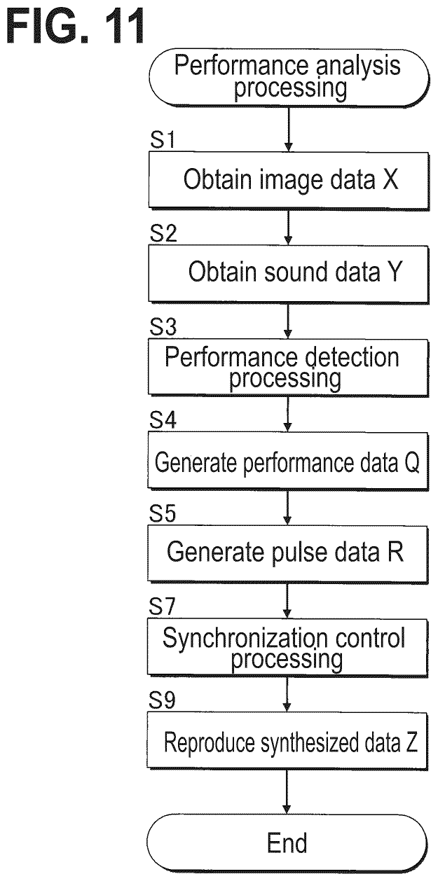

FIG. 11 is a flowchart of an example detail procedure for the performance analysis processing according to this embodiment. Upon start of the performance analysis processing, the controller 41 obtains the image data X (S1), obtains the sound data Y (S2), performs the performance detection processing (S3), and generates the performance data Q (S4), similarly to the previous embodiment. Upon generating the performance data Q, the controller 41 generates the pulse data R based on the performance data Q (S5). That is, the controller 41 serves as the pulse data generator 56.

The controller 41 serves as the synchronization controller 55 to perform the synchronization control processing illustrated in FIG. 10 (S7). Specifically, the controller 41 synchronizes the image data X and the sound data Y with each other using the pulse data R to generate the synthesized data Z. The synthesized data Z is reproduced (S9) in a manner similar to the previous embodiment.

In this embodiment, the image data X is analyzed to generate the performance data Q, which serves as a chronological reference for the image data X, similarly to the previous embodiment. Also in this embodiment, the pulse data R is used to synchronize the image data X and the sound data Y with each other. That is, the image data X and the sound data Y are synchronized with each other with the pulse structure of a musical piece taken into consideration. This ensures that the image data X and the sound data Y are synchronized with each other more highly accurately than the previous embodiment, in which the performance data Q, which specifies time points of sound emission from the bass drum 11, is used to the image data X and the sound data Y are synchronized with each other.

In this embodiment, a configuration to generate the pulse data R is added to the previous embodiment, in which the image data X indicating the percussion instrument 1 is analyzed to detect a vibration of the drum set 10 (the head 112). This embodiment's configuration to generate the pulse data R is also added to the previous embodiment in which the image data X indicating the beater 121 is analyzed to detect a striking of the drum set 10.

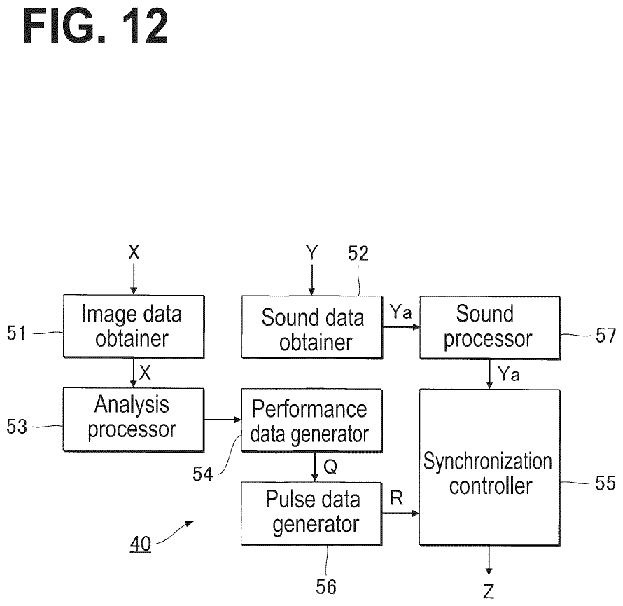

FIG. 12 is a block diagram of an example functional configuration of the performance analysis system 40 according to an embodiment. The controller 41 according to this embodiment executes a program stored in the storage 42 to function as a sound processor 57, in addition to the elements used in the immediately previous embodiment, namely, the image data obtainer 51, the sound data obtainer 52, the analysis processor 53, the performance data generator 54, the synchronization controller 55, and the pulse data generator 56.

The sound indicated by the sound data Y includes desired sound and undesired sound. The desired sound (which can also be referred to as “object sound”) is performance sound that was initially aimed to be obtained, such as sound of playing the bass drum 11. The undesired sound (which can also be referred to as “non-object sound”) is performance sound of a musical instrument other than the bass drum 11. Examples of the undesired sound include: performance sound of another drum of the drum set 10 than the bass drum 11; and performance sound of a variety of musical instruments played near the drum set 10. The sound processor 57 performs sound processing on the sound data Y to generate the sound data Ya.

The sound processing is processing of emphasizing the desired sound relative to the undesired sound. For example, the desired sound, which is performance sound of the bass drum 11, exists in a low tonal range as compared with the undesired sound. In light of this fact, the sound processor 57 performs lowpass filter processing on the sound data Y by employing a low-pass filter with its cutoff frequency adjusted to the highest frequency within the bass drum 11's tonal range. An undesired sound whose frequency exceeds the cutoff frequency is reduced or removed by the sound processing. Therefore, the desired sound is emphasized or extracted in the sound data Ya that has been subjected to the sound processing. Sound source separation processing is also used as the sound processing on the sound data Y The sound source separation processing is processing of emphasizing the desired sound relative to the undesired sound using the difference between the direction in which the desired sound travels toward the sound obtainer 31 and the direction in which the undesired sound travels toward the sound obtainer 31.

The synchronization controller 55 according to this embodiment synchronizes the image data X with the sound data Ya that has been subjected to the sound processing. The synchronization control processing according to this embodiment is identical to the synchronization control processing according to the immediately previous embodiment except that the processing target is the sound data Ya, instead of the sound data Y That is, the synchronization controller 55 synchronizes the image data X and the sound data Ya with each other using the pulse data R.

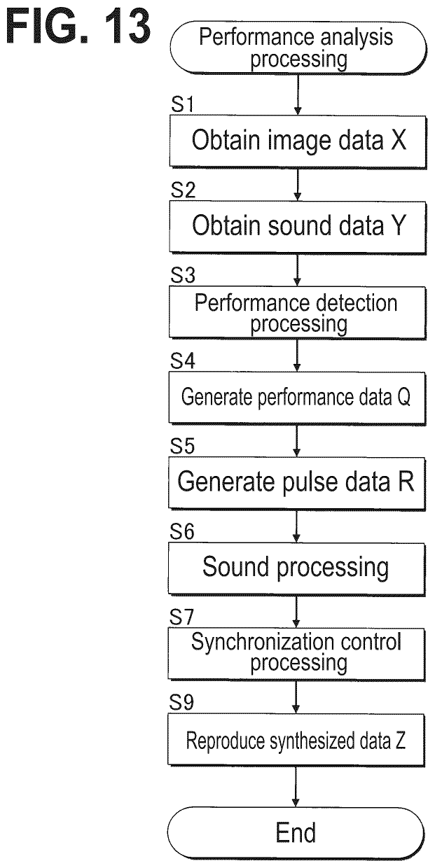

FIG. 13 is a flowchart of an example detail procedure for the performance analysis processing according to this embodiment. In this embodiment, sound processing performed on the sound data Y (S6) is added to the performance analysis processing according to the immediately previous embodiment. Specifically, the controller 41 performs sound processing on the sound data Y to generate the sound data Ya. That is, the controller 41 serves as the sound processor 57. The controller 41 performs synchronization control processing using the pulse data R to generate the synthesized data Z (S7). The performance analysis processing according to this embodiment is otherwise identical to the performance analysis processing according to the immediately previous embodiment.

This provides effects similar to the effects provided by the immediately previous embodiment. Also in the fourth previous embodiment, the performance sound of the bass drum 11 (desired sound) is emphasized in the sound data Y This ensures that the image data X and the sound data Y are synchronized more highly accurately than a configuration in which the performance sound indicated by the sound data Y also includes a substantial amount of undesired sound.

In this embodiment, the sound processing performed on the sound data Y is added to the previous embodiment. Similarly, the sound processing performed on the sound data Y may be applied to the second previous embodiment. While this embodiment includes the immediately previous embodiment's configuration to generate the pulse data R, it is possible to omit this configuration in this embodiment. That is, the synchronization controller 55 may, using the performance data Q, synchronize the image data X with the sound data Y that has been subjected to the sound processing.

It is to be noted that the sound processing exemplified above is also applied to the first and second previous embodiments. It is also to be noted that while this embodiment includes the immediately previous embodiment's configuration to generate the pulse data R, it is possible to omit the configuration to generate the pulse data R (S5) in this embodiment. That is, in this embodiment, the synchronization controller 55 may synchronize the image data X and the sound data Y with each other using the performance data Q, similarly to the first or second previous embodiment.

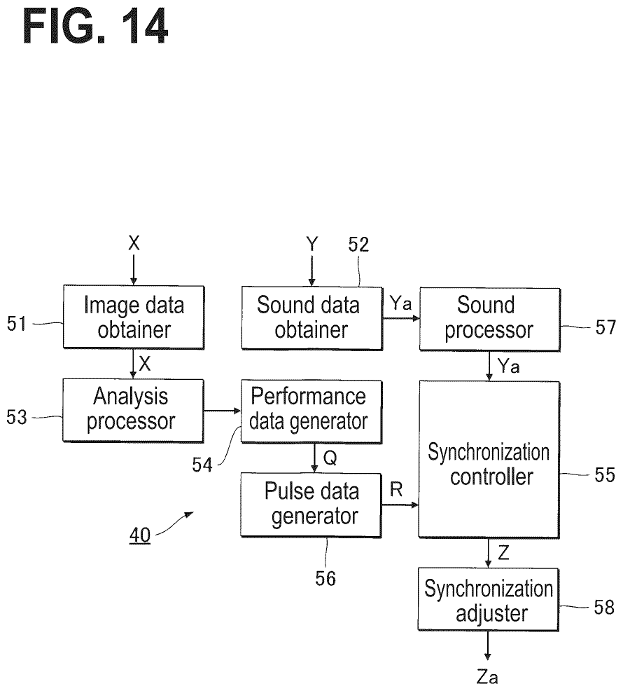

FIG. 14 is a block diagram of an example functional configuration of the performance analysis system 40 according to an embodiment. The controller 41 according to this embodiment executes a program stored in the storage 42 to function as a synchronization adjuster 58, in addition to the elements used in the immediately previous embodiment, namely, the image data obtainer 51, the sound data obtainer 52, the analysis processor 53, the performance data generator 54, the synchronization controller 55, the pulse data generator 56, and the sound processor 57.

The synchronization controller 55 according to this embodiment synchronizes the image data X and the sound data Ya with each other, similarly to the immediately previous embodiment. There may be a case, however, that the image data X that has been subjected to the processing performed by the synchronization controller 55 and the sound data Ya are in a chronological relationship (hereinafter referred to as “synchronization relationship”) that is not as intended by the user U. There also may be a case that the image data X and the sound data Ya are not accurately synchronized with each other. The synchronization adjuster 58 illustrated in FIG. 14 changes the position on the time axis of one of the sound data Ya and the image data X that has been subjected to the synchronization control processing relative to the position of the other of the sound data Ya and the image data X (that is, synchronization adjuster 58 changes the synchronization relationship between the sound data Ya and the image data X).

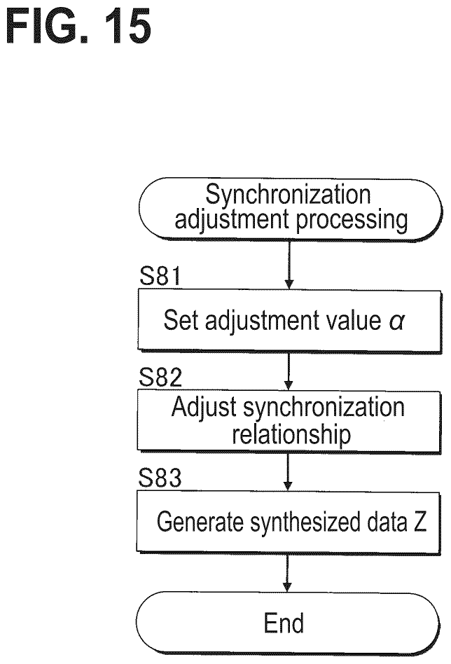

FIG. 15 is a flowchart of an example detail procedure for the synchronization adjuster 58's processing of adjusting the chronological relationship between the image data X and the sound data Ya (this processing will be hereinafter referred to as “synchronization adjustment processing”). Upon start of the synchronization adjustment processing, the synchronization adjuster 58 sets an adjustment value a (S81).

While listening to and viewing the image and sound indicated by the synthesized data Z reproduced by the reproducer 47, the user U operates the operator 44 to make an instruction to adjust the synchronization relationship between the image data X and the sound data Ya. Specifically, the user U adjusts the chronological relationship between the image data X and the sound data Ya indicated by the synthesized data Z to make the synchronization relationship a desired relationship. For example, in a case that the user U has determined that the sound data Ya is delayed relative to the image data X, the user U makes an instruction to move the sound data Ya forward (in the direction opposite to the time axis) by a predetermined amount relative to the image data X. In a case that the user U has determined that the sound data Ya is advanced relative to the image data X, the user U makes an instruction to move the sound data Ya backward (in the direction of the time axis) by a predetermined amount relative to the image data X. The synchronization adjuster 58 sets the adjustment value a in response to the instruction from the user U. In a case that the user U has made an instruction to move the sound data Ya forward relative to the image data X, the synchronization adjuster 58 sets the adjustment value a to a negative number that is based on the instruction from the user U. In a case that the user U has made an instruction to move the sound data Ya backward relative to the image data X, the synchronization adjuster 58 sets the adjustment value a to a positive number that is based on the instruction from the user U.

Based on the adjustment value a, the synchronization controller 55 adjusts the position on the time axis of one of the image data X and the sound data Ya relative to the position of the other of the image data X and the sound data Ya (that is, the synchronization controller 55 adjusts the synchronization relationship between the image data X and the sound data Ya) (S82). Specifically, in a case that the adjustment value a is a negative number, the synchronization controller 55 moves the sound data Ya forward relative to the image data X by a movement that is based on the absolute value of the adjustment value a. In a case that the adjustment value a is a positive number, the synchronization controller 55 moves the sound data Ya backward relative to the image data X by a movement that is based on the absolute value of the adjustment value a. The synchronization controller 55 generates the synthesized data Z such that the synchronization relationship between the image data X and the sound data Y has been adjusted (S83).

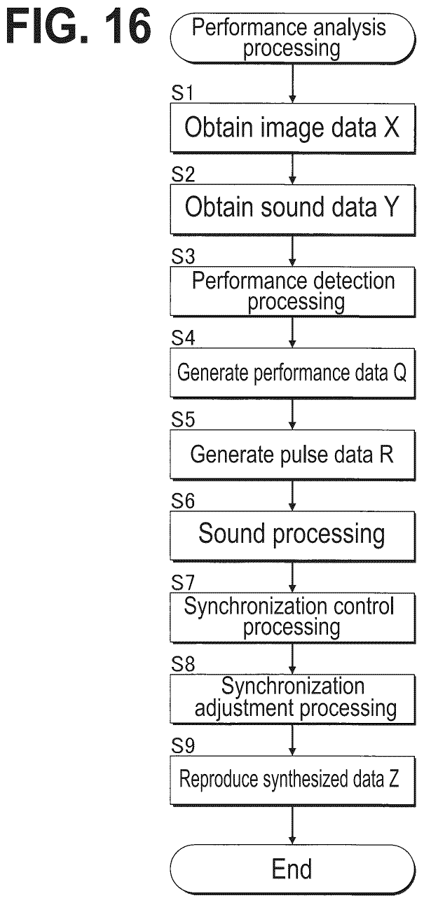

FIG. 16 is a flowchart of an example detail procedure for performance analysis processing according to this embodiment. In this embodiment, the synchronization adjustment processing exemplified in FIG. 15 is added to the performance analysis processing according to the immediately previous embodiment. Specifically, the controller 41 serves as the synchronization adjuster 58 to adjusts the synchronization relationship between the image data X and the sound data Ya based on the adjustment value a (S8). The performance analysis processing according to this embodiment is otherwise identical to the performance analysis processing according to the immediately previous embodiment. The synthesized data Z generated by the synchronization adjustment processing is reproduced by the reproducer 47 (S9).

This embodiment provides effects similar to the effects provided by the immediately previous embodiment. Also in this embodiment, the position on the time axis of one of the image data X and the sound data Ya can be adjusted relative to the other of the image data X and the sound data Ya after the synchronization control processing. Further in this embodiment, the adjustment value a is set at an instruction from the user U. This ensures that the position of one of the image data X and the sound data Ya can be adjusted as intended by the user U relative to the other of the image data X and the sound data Ya.

It is to be noted that the adjustment of the synchronization relationship exemplified above is also applied to the first and second previous embodiments. Also in this embodiment, the configuration to generate the pulse data R (S5) may be omitted. That is, in this embodiment, the synchronization controller 55 may synchronize the image data X and the sound data Y with each other using the performance data Q, similarly to the first or second previous embodiment. Also in this embodiment, the sound processing performed on the sound data Y (S6) may also be omitted. That is, in this embodiment, the synchronization controller 55 may synchronize the image data X and the sound data Y with each other, similarly to the first or second previous embodiment.

The synchronization adjuster 58 according to the immediately previous embodiment sets the adjustment value a at an instruction from the user U, as described above. The synchronization adjuster 58 according to an embodiment sets the adjustment value a using the trained model M. This embodiment is identical in configuration and operation to the immediately previous embodiment except in the setting of the adjustment value a.

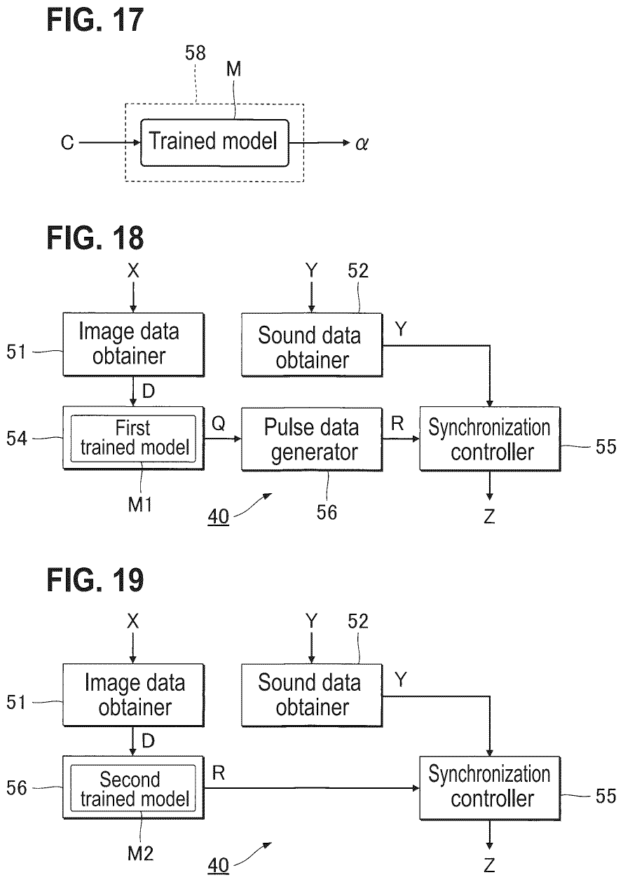

FIG. 17 is a schematic illustration of the setting of the adjustment value a according to this embodiment. The synchronization adjuster 58 processes the input data C using the trained model M to generate the adjustment value a. In this embodiment, the image data X is supplied to the trained model M as the input data C.

The image data X and the sound data Ya that have been synchronized by the synchronization controller 55 tend to be in a chronological relationship (synchronization relationship) that depends on a condition associated with the bass drum 11. An example condition associated with the bass drum 11 is the type (product model) or size of the bass drum 11. For example, an electronic drum is more likely to experience the above-described delay than an acoustic drum. The above-described delay is that the sound data Ya is delayed relative to the image data X after the synchronization. Thus, the adjustment value a, which is used to appropriately adjust the synchronization relationship, depends on the condition associated with the bass drum 11 and indicated by the image data X. With this dependency taken into consideration, the trained model M according to this embodiment is a statistical estimation model that has been trained to learn, by machine learning, a relationship between the input data C (the image data X) and the adjustment value a. Specifically, the trained model M outputs a statistically appropriate adjustment value a in response to the input data C. The image data X is used as input data C indicating the condition associated with the bass drum 11. The condition reflected in the image data X is regarding an appearance of the bass drum 11, such as its type or model. This enables the trained model M to generate an adjustment value a that is statistically appropriate for the condition. It is to be noted that information such as the type (model) or size of the bass drum 11 as indicated by the image data X may be supplied to the trained model M as the input data C. It is also to be noted that the feature quantity F, which is calculated based on the image data X, may be supplied to the trained model M as the input data C.

Specifically, the trained model M is implemented by a combination of: a program that causes the controller 41 to do an arithmetic and/or logic operation to generate the adjustment value a based on the input data C; and a plurality of variables (such as weight value and bias) applied to this arithmetic and/or logic operation. The trained model M is implemented by, for example, a deep neural network. For example, any form of deep neural network such as a recurrent neural network (RNN) and a convolutional neural network may be used as the trained model M. The trained model M may be configured by a combination of a plurality of kinds of deep neural networks. It is also possible that a long short-term memory (LSTM) or an additional-nature element such as Attention is incorporated in the trained model M.

The trained model M described above is established by machine learning using a plurality of training data. Each of the plurality of training data includes: training input data C (image data X) indicating the bass drum 11; and a training adjustment value a (correct value) that is appropriate for the bass drum 11. In the machine learning, the plurality of variables of the trained model M are repetitively updated to reduce the error between adjustment value a generated by a provisional trained model M based on the input data C of each training data and adjustment value a in the training data. That is, the trained model M learns a relationship between the training input data C, which is based on an image of the percussion instrument, and the training adjustment value a.

In the synchronization adjustment processing, the synchronization adjuster 58 inputs, in the trained model M, the image data X as the input data C to obtain the adjustment value a (S81). This embodiment is identical to the immediately previous embodiment in the processing of adjusting the synchronization relationship based on the adjustment value a (S82) and in the processing of generating the synthesized data Z from the image data X and the sound data Ya that have been adjusted (S83).

This embodiment provides effects similar to the effects provided by the immediately previous embodiment. Also in this embodiment, the adjustment value a is set using the trained model M. This ensures that a statistically appropriate adjustment value a is set in response to the input data C.

It is to be noted that the adjustment of the synchronization relationship exemplified above is also applied to the first and second previous embodiments. Also in this embodiment, the configuration to generate the pulse data R (S5) may be omitted. That is, in this embodiment, the synchronization controller 55 may synchronize the image data X and the sound data Y with each other using the performance data Q, similarly to the first or second previous embodiment. Also, in this embodiment, the sound processing performed on the sound data Y (S6) may also be omitted. Specifically, in this embodiment, the synchronization controller 55 may synchronize the image data X and the sound data Y with each other, similarly to the first or second previous embodiment.

### Modifications

Modifications of the above-described embodiments will be described below. The plurality of configurations exemplified below may be arbitrarily selected and combined in any manner deemed convenient insofar as they are not inconsistent with each other.

(1) In the above-described embodiments, the synthesized data Z is generated from a single piece of image data X and a single piece of sound data Y Another possible example is that a plurality of images data X generated by different recorders 20 are used to generate the synthesized data Z. For each of the plurality of image data X, the performance data Q is generated by the performance data generator 54; and the pulse data R is generated by the pulse data generator 56. The synchronization controller 55 synchronizes the plurality of images data X and sound data Y with each other to generate the synthesized data Z. With this configuration, a multi-angle image showing, in parallel, a plurality of images taken in different places and at different angles is generated. The synchronization controller 55 may generate synthesized data Z in which a plurality of image data X are sequentially switched in time division. For example, the synchronization controller 55 generates synthesized data Z in which images are switched at intervals corresponding to the pulse structures indicated by the pulse data R. The intervals corresponding to the pulse structures are equivalent to, for example, n pulse structures (n is a natural number equal to or more than 1).

(2) In the above-described embodiments, the synthesized data Z is generated from a single piece of image data X and a single piece of sound data Y Another possible example is that a plurality of sound data Y generated by different recorders 30 are used to generate the synthesized data Z. The synchronization controller 55 combines the plurality of sound data Y at a predetermined ratio and synchronizes the combined sound data Y with the image data X. The synchronization controller 55 may also synchronize each of the plurality of sound data Y with the image data X and generate synthesized data Z in which the plurality of sound data Y are sequentially switched in time division.

(3) In the above-described embodiments, the recorder 20 generates the image data X, and the recorder 30 generates the sound data Y Another possible example is that one or both of the recorder 20 and the recorder 30 generates both the image data X and the sound data Y Another possible example is that a plurality of recorders each transmit image data X or sound data Y to the performance analysis system 40. Thus, the number of recorders is not predetermined and can be any number. Also, the number of kinds of data transmitted by the recorder(s) (that is, whether one or both of the image data X and the sound data Y is transmitted) is not predetermined and can be any number. Thus, as exemplified in modification (1) or modification (2), the total number of the image data X or the total number of the sound data Y obtained by the performance analysis system 40 is not predetermined and can be any number.

(4) In the above-described embodiments, the image data obtainer 51 obtains the image data X from the recorder 20. Another possible example is that the image data X is data stored in the storage 42. In this case, the image data obtainer 51 obtains the image data X from the storage 42. As can be understood from the foregoing description, the image data obtainer 51 is an optional means for obtaining the image data X, and encompasses: an element that receives the image data X from an external device such as the recorder 20; and an element that obtains the image data X from the storage 42.

(5) In the above-described embodiments, the sound data obtainer 52 obtains the sound data Y from the recorder 30. Another possible example is that the sound data Y is data stored in the storage 42. In this case, the sound data obtainer 52 obtains the sound data Y from the storage 42. As can be understood from the foregoing description, the sound data obtainer 52 is an optional means that obtains the sound data Y, and encompasses: an element that receives the sound data Y from an external device such as the recorder 30; and an element that obtains the sound data Y from the storage 42.

(6) In the above-described embodiments, the image data X and the sound data Y are recorded in parallel to each other. The image data X and the sound data Y, however, may not necessarily be recorded in parallel to each other. There may be a case that the image data X and the sound data Y are recorded at different times or in different places. Even in this case, the image data X and the sound data Y can be synchronized with each other using the performance data Q or the pulse data R. Also, the performance indicated by the image data X and the performance indicated by the sound data Y may be different from each other in tempo. In a case that the performance indicated by the image data X and the performance indicated by the sound data Y are different from each other in tempo, the synchronization controller 55 aligns the tempo of the sound data Y with the tempo of the image data X by a known time stretching technique, and then synchronizes the image data X and the sound data Y with each other. It is to be noted that the synchronization controller 55 identifies the tempo of the image data X from the performance data Q or the pulse data R, and applies time stretching to the sound data Y to make its tempo align with the above-described tempo. That is, the performance data Q or the pulse data R, which is used to synchronize the image data X and the sound data Y, is repurposed for time stretching of the sound data Y.

(7) In the previous embodiment, a vibration of the head 112 of the bass drum 11 is detected. What is detected using the image data X, however, will not be limited to a vibration of the bass drum 11. For example, a vibration of any other drum that is part of the drum set 10 (such as a tom-tom, a floor tom, and a snare drum) may be detected by analyzing the image data X. That is, the image indicated by the image data X may include an image of another drum of the drum set 10 than the bass drum 11.

Also in the above-described embodiments, a primary focus is placed on the bass drum 11, which is an acoustic drum. It is possible, however, that the image data X indicates an image of an electronic drum. In this case, the electronic drum includes a pad (such as a rubber pad), instead of the head 112. The analysis processor 53 analyzes the image data X to detect a vibration of the pad of the electronic drum. Also, the image data X may include an image of an idiophone such as a cymbal or an image of a keyboard (mallet) percussion instrument such as a xylophone. The analysis processor 53 analyzes the image data X to detect a vibration of the idiophone. As can be understood from the foregoing description, the analysis processor 53 can be comprehensively expressed as an element that detects a vibration caused by striking of the percussion instrument. The type of the percussion instrument can be chosen arbitrarily. It is to be noted that idiophones such as cymbals generally have higher vibration amplitudes and longer vibration durations than the heads of membranophones such as the head 112 of the bass drum 11. Thus, the analysis processor 53 uses a greater processing load for vibration detection in an idiophone than in a membranophone. From the viewpoint of minimizing the processing load for vibration detection in a percussion instrument, a preferred embodiment is to detect a vibration of a membranophone. The percussion instrument includes a vibrating element comprehensively expressed as vibration body.

It is to be noted that a support structure that supports the body of the musical instrument, which can be an idiophone or a membranophone, is encompassed within the concept of “percussion instrument”. For example, a cymbal stand, which supports a cymbal, and a hi-hat stand, which supports a hi-hat, are vibration bodies that are caused to vibrate by striking of the cymbal and the hi-hat. As such, cymbal stands and hi-hat stands are regarded as elements constituting part of percussion instruments. Also, a bottom head and the body 111 vibrate sympathetically with (in harmony with) the striking of the head 112. As such, the bottom head and the body 111 are encompassed within the concept of the vibration body. The vibration body is a body whose vibrations are detected by the analysis processor 53. As seen from the above description, the vibration body encompasses a direct element directly struck by the user U and an indirect element that vibrates in coordination with the direct element. That is, the vibration body can be comprehensively expressed as an element that is caused to vibrate by a performance and/or playing of a musical instrument.

(8) In the second previous embodiment, the image data X indicates an image of the foot pedal 12. The beater 121, whose image is included in the image of the image data X, will not be limited to the foot pedal 12. For example, the image of the image data X may include an image of a stick used to strike various percussion instruments such as a tom-tom, a floor tom, and a snare drum. In this case, the analysis processor 53 analyzes the image data X to detect a vibration of the stick. For another example, the image of the image data X may include an image of a mallet used to strike a keyboard percussion instrument such as a xylophone. In this case, the analysis processor 53 analyzes the image data X to detect a vibration of the mallet. As seen from the above description, the analysis processor 53 can be comprehensively expressed as an element that detects a striking action performed using a striking body. The beater 121, the stick, and the mallet are examples of the striking body. That is, the striking body can be comprehensively expressed as an element used for striking actions in a performance.

As can be understood from modifications (7) and (8) exemplified above, the analysis processor 53 can be comprehensively expressed as an element that detects a change in a percussion instrument caused by striking of the percussion instrument. A change in a percussion instrument caused by striking of the percussion instrument encompasses a vibration of a vibration body and a striking action performed using a striking body. It is to be noted that a striking body can be construed as a vibration body of a percussion instrument.

(9) In the above-described embodiments, an image of the bass drum 11 or the foot pedal 12 may not necessarily be included in a part of the image indicated by the image data X. Still, from the viewpoint of accurately synchronizing the image data X and the sound data Y from a start point of a musical piece, an image of the bass drum 11 or the foot pedal 12 is preferably included in the image of the image data X from the start point of the musical piece. It is also possible, however, for the synchronization controller 55 to estimate the start point of the musical piece by analyzing the performance data Q and the pulse data R.

(10) In the previous embodiment, the analysis processor 53 identifies a target region from the image of the image data X. Another possible example is that the identification of a target region (Sa 31) is omitted. For example, in a case that only an image of the head 112 of the bass drum 11 is included in the image indicated by the image data X, a vibration of the head 112 can be detected by analyzing the image data X without identifying a target region. Thus, the identification of a target region can be omitted. In any embodiment in which the analysis processor 53 detects a vibration, the identification of a target region by the analysis processor 53 may be omitted.

(11) The trained model M according to the sixth previous embodiment will not be limited to a deep neural network. For example, a statistical estimation model such as an HMM (Hidden Markov Model) and an SVM (Support Vector Machine) may be used as the trained model M.

(12) In the previous embodiment, the image data X is used as the input data C. The input data C, however, will not be limited to the image data X. As described above, there is such a tendency that the synchronization relationship depends on a condition associated with the bass drum 11. Under the circumstances, the synchronization controller 55 may identify a condition associated with the bass drum 11 by analyzing the image data X, and then supply input data C indicating the condition to the trained model M. Examples of the condition associated with the bass drum 11 include size and/or type of the bass drum 11. The synchronization controller 55 performs object-detection processing on the image data X to identify the condition associated with the bass drum 11. As can be understood from the foregoing description, the input data C can be comprehensively expressed as data that is based on the image data X. The input data C encompasses the image data X itself and data generated based on the image data X.

(13) The order of the steps of the performance analysis processing may be changed in any manner deemed convenient from the order exemplified in the above-described embodiments. For example, obtaining the image data X (S1) and obtaining the sound data Y (S2) may be performed in reverse order. Also, obtaining the sound data Y (S2) and the performance detection processing by the analysis processor 53′ (S3) may be performed in reverse order.

(14) In the first and second previous embodiments, the image data X is analyzed to detect a change in a percussion instrument, and the performance data Q is generated using the detected change. Another possible example is that a trained model M1 (hereinafter referred to as “first trained model”) is used to generate the performance data Q, as exemplified in FIG. 18. The first trained model M1 is a statistical estimation model that has been trained to learn, by machine learning, a relationship between input data D and the performance data Q. The input data D is data that is based on the image data X. The input data D is supplied to the first trained model M1. Examples of the input data D include the image data X itself, and the above-described feature quantity F, which is calculated based on the image data X. The controller 41 (the performance data generator 54) processes the input data D using the first trained model M1 to generate the performance data Q. It is to be noted that in the configuration illustrated in FIG. 18, the analysis processor 53, which is exemplified in the above-described embodiments, is omitted. Also in the configuration illustrated in FIG. 18, the image indicated by the image data X includes at least one of the vibration body and the striking body of the percussion instrument.

The first trained model M1 is implemented by a combination of: a program that causes the controller 41 to do an arithmetic and/or logic operation to generate the performance data Q based on the input data D; and a plurality of variables (such as weight value and bias) applied to this arithmetic and/or logic operation. The first trained model M1 is implemented by, for example, a deep neural network such as a convolutional neural network and a recurrent neural network.

The first trained model M1 is established by machine learning using a plurality of training data. Each of the plurality of training data includes learning input data D and learning performance data Q (correct value) suitable for the input data D. In the machine learning, the plurality of variables of the first trained model M1 are repetitively updated to reduce the error between the performance data Q generated by a provisional first trained model M1 based on the input data D of each training data and the performance data Q in the training data. That is, the first trained model M1 learns a relationship between the training input data D, which is based on an image of the percussion instrument, and the learning performance data Q. The generation of the pulse data R using the performance data Q and the synchronization control processing using the pulse data R are respectively identical to the generation of the pulse data R using the performance data Q and the synchronization control processing using the pulse data R performed in the above-described embodiments.

In the configuration illustrated in FIG. 18, the first trained model M1 processes the input data D, which is based on the image data X of the percussion instrument 1, to generate the performance data Q. That is, similarly to the first or second previous embodiment, the performance data Q, which serves as a chronological reference related to the playing of the percussion instrument 1, is generated based on the image data X.

It is to be noted that the configuration of the fourth previous embodiment, in which the sound processor 57 processes the sound data Y, and the configuration of the fifth or sixth previous embodiment, in which the synchronization adjuster 58 performs the synchronization adjustment processing, are applicable to the configuration illustrated in FIG. 18.

(15) In FIG. 18, the first trained model M1 processes the input data D to generate the performance data Q. Another possible example is that as exemplified in FIG. 19, a second trained model M2 processes the input data D to generate the pulse data R. The second trained model M2 is a statistical estimation model that has been trained to learn, by machine learning a relationship between the input data D and the pulse data R. The input data D supplied to the second trained model M2 is data that is based on the image data X. Examples of the input data D include the image data X itself, and the above-described feature quantity F, which is calculated based on the image data X. The controller 41 (the pulse data generator 56) generates the pulse data R by processing the input data D using the second trained model M2. It is to be noted that in the configuration illustrated in FIG. 19, the analysis processor 53 and the performance data generator 54, which are exemplified in the above-described embodiments, are omitted. The image indicated by the image data X includes at least one of the vibration body and the striking body of the percussion instrument.

The second trained model M2 is implemented by a combination of: a program that causes the controller 41 to do an arithmetic and/or logic operation to generate the pulse data R based on the input data D; and a plurality of variables (such as weight value and bias) applied to this arithmetic and/or logic operation. The second trained model M2 is implemented by, for example, a deep neural network such as a convolutional neural network and a recurrent neural network.

The second trained model M2 is established by machine learning using a plurality of training data. Each of the plurality of training data includes learning input data D and learning pulse data R (correct value) suitable for the input data D. In the machine learning, the plurality of variables of the second trained model M2 are repetitively updated to reduce the error between the pulse data R generated by a provisional second trained model M2 based on the input data D of each training data and the pulse data R in the training data. That is, the second trained model M2 learns a relationship between the training input data D, which is based on an image of the percussion instrument, and the learning pulse data R. The synchronization control processing using the pulse data R is identical to the synchronization control processing performed in the above-described embodiments.

In the configuration illustrated in FIG. 19, the second trained model M2 processes the input data D, which is based on the image data X of the percussion instrument 1, to generate the pulse data R. That is, similarly to the third previous embodiment, the pulse data R, which serves as a chronological reference related to the playing of the percussion instrument 1, is generated based on the image data X. It is to be noted that the configuration of the fourth previous embodiment, in which the sound processor 57 processes the sound data Y, and the configuration of the fifth or sixth previous embodiment, in which the synchronization adjuster 58 performs the synchronization adjustment processing, are applicable to the configuration illustrated in FIG. 19.

(16) In the above-described embodiments, the percussion instrument 1 includes a vibration body (the head 112) and a striking body (the beater 121). In the configuration in which the performance data Q or the pulse data R is generated based on image data X indicating the striking body, the performance data Q or the pulse data R can be generated even if the percussion instrument 1 does not include a vibration body. Therefore, the above-described embodiments are also applicable to air drums, in which case performance sound is reproduced based on the user U's motion of swinging a striking body. As can be understood from the foregoing description, the term “percussion instrument”, as used in the present disclosure, encompasses air drums. That is, an image of a percussion instrument and vibration detection are not essential in the configuration in which the performance data Q or the pulse data R is generated based on image data X indicating an image of the striking body.

(17) The functions of the performance analysis system 40 is implemented through the collaborative operation of a single processor or a plurality of processors constituting the controller 41 and programs stored in the storage 42, as described above. These programs may be provided in the form of a computer-readable storage medium and installed on a computer. An example of the storage medium is a non-transitory storage medium. A preferable example is an optical storage medium (optical disc) such as a CD-ROM. Another possible example is any other known form of storage medium such as a semiconductor storage medium and a magnetic storage medium. It is to be noted that the non-transitory storage medium according to the present disclosure encompasses any form of storage medium excluding a transitory propagating signal. A volatile storage medium is encompassed within the non-transitory storage medium. The program may be distributed from a distribution device via a communication network. In this case, a storage medium that stores the program in the distribution device corresponds to the non-transitory storage medium.

### H: ADDITIONAL NOTES

The above-described embodiments can be exemplified by the following configurations.

According to one embodiment (embodiment 1), a performance analysis method is implemented by a computer system. The performance analysis method includes obtaining image data generated by imaging a percussion instrument. The performance analysis method also includes analyzing the image data to detect a change in the percussion instrument caused by striking of the percussion instrument. The performance analysis method also includes, based on the detected change, generating performance data indicating the striking of the percussion instrument. The performance analysis method also includes, based on the performance data, generating pulse data indicating a pulse structure.

In this embodiment, image data generated by imaging a percussion instrument is analyzed to detect a change in the percussion instrument. Based on the detected change, the performance data Q, which indicates striking of the percussion instrument, is generated. That is, the performance data, which serves as a chronological reference for the image data X, is generated based on the image data. Also, pulse data indicating a pulse structure is generated based on the performance data. This ensures that various kinds of processing are performed using the pulse structure.

The phrase “a change in the percussion instrument”, as used in the present disclosure, is intended to mean a vibration occurring on a vibration body of a percussion instrument or a striking action performed using a striking body of a percussion instrument. The term “vibration body”, as used in the present disclosure, is intended to mean a part of a percussion instrument which part is caused to vibrate by striking of the percussion instrument. For example, in a case of a membranophone such as a drum, the head (strike surface) of the membranophone, which is struck during a performance, is encompassed within the vibration body. In addition, the bottom head of the membranophone, which vibrates sympathetically (in harmony) with the head, is encompassed within the vibration body. For another example, in a case of a idiophone such as a cymbal, the body of the idiophone struck in a performance is encompassed within the vibration body. It is to be noted that the “vibration of the percussion instrument” will not be limited to a vibration of the percussion instrument's vibration body directly struck by the user. For example, a vibration of a member of the percussion instrument which member supports the vibration body is encompassed within the “vibration of the percussion instrument”.

The term “striking body”, as used in the present disclosure, is intended to mean an element used to strike a percussion instrument. Example of the striking body include a stick or a beater to strike a drum, and a mallet to strike a keyboard (mallet) percussion instrument such as a xylophone. Another possible case is that a percussion instrument is struck by a performer's body (for example, hand). In this case, the performer's body is encompassed within the concept of the “striking body”.

The term “performance data”, as used in the present disclosure, is intended to mean any form of data indicating striking of a percussion instrument. An example of the performance data is time-series data in which emitted sound data and time point data are aligned. The emitted sound data indicates striking of a percussion instrument. The time point data specifies the position of the striking on the time axis. It is to be noted that the emitted sound data may not only indicate a striking occurrence but also specify the intensity of the striking.

The term “pulse structure”, as used in the present disclosure, is intended to mean a pulse structure (rhythm) of a musical piece. Atypical example of the “pulse structure” is a rhythm pattern structure (time signature) specified by a combination of a plurality of beats including strong beats and weak beats and the time points at which the beats occur.

In a specific example (embodiment 2) of embodiment 1, the percussion instrument includes a vibration body vibratable by the striking of the percussion instrument. Detecting the change in the percussion instrument includes, from an image indicated by the image data, identifying a target region of the percussion instrument. The target region is where the vibration body exists. Detecting the change in the percussion instrument also includes detecting a vibration of the vibration body based on a change in the image in the target region. In this embodiment, a target region of the vibration body of the percussion instrument is identified from the image indicated by the image data. By analyzing the image data, a vibration of the vibration body is detected highly accurately.

In a specific example (embodiment 3) of embodiment 1 or 2, the percussion instrument includes a striking body used for the striking of the percussion instrument. Detecting the change in the percussion instrument includes identifying the striking body from an image indicated by the image data. Detecting the change in the percussion instrument also includes, based on a change in the image showing the striking body, detecting the striking of the percussion instrument struck by the striking body. In this embodiment, image data generated by imaging a striking body is analyzed to detect a striking made using the striking body. Then, based on the detected striking of the percussion instrument, performance data indicating the striking is generated. That is, the performance data, which serves as a chronological reference for the image data, is generated based on the image data. Also, pulse data indicating a pulse structure is generated based on the performance data. This ensures that various kinds of processing are performed using the pulse structure.

A specific example (embodiment 4) of the performance analysis method according to any one of embodiments 1 to 3, further includes obtaining sound data indicating a performance sound, and synchronizing the image data and the sound data with each other using the pulse data. In this embodiment, pulse data is used to synchronize image data and sound data with each other. That is, the image data and the sound data are synchronized with each other with the pulse structure of the musical piece taken into consideration. This ensures that the image data and the sound data are synchronized with each other more highly accurately than a configuration in which performance data is used to synchronize the image data and the sound data with each other.

The term “sound data”, as used in the present disclosure, is intended to mean any data indicating performance sound. An example of the “sound data” is data indicating performance sound of a musical piece identical to the musical piece played in the image indicated by the image data. It is to be noted, however, that the musical piece played in the image indicated by the image data may not necessarily completely identical to the musical piece indicated by the performance sound of the sound data. It is to be noted that the obtaining of the image data and the obtaining of the sound data may be performed in any order.

The term “synchronization” of the image data and the sound data, as used in the present disclosure, is intended to mean processing of adjusting a chronological correlation between the image data and the sound data. Atypical example of the “synchronization” is to adjust the position on the time axis of one of the image data and the sound data relative to the position of the other of the image data and the sound data so that performance sound indicated by the sound data at an arbitrary time point in a musical piece correlates on the time axis with (for example, aligns on the time axis with) the image indicated by the image data at this time point. It is to be noted that the image data and the sound data may not necessarily synchronized with each other throughout the time axis. For example, insofar as the image data and the sound data correlate to each other at a particular time point on the time axis, this relationship between the image data and the sound data can be construed as a “synchronization”, even if there is a chronological misalignment between the image data and the sound data at the above time point and this chronological misalignment increases over time from the time point. It is also to be noted that the “synchronization” will not be limited to the relationship in which the image data and the sound data are chronologically aligned with each other. That is, processing of adjusting the chronological correlation between the image data and the sound data is encompassed within the concept of “synchronization” if the time difference of one of the image data and the sound data relative to the other of the image data and the sound data is adjusted to a predetermined value as a result of the processing.

In a specific example (embodiment 5) of embodiment 4, the performance sound indicated by the sound data includes a performance sound of the percussion instrument and a performance sound of an other musical instrument different from the percussion instrument. The performance analysis method further includes performing sound processing on the sound data. The sound processing includes emphasizing the performance sound of the percussion instrument relative to the performance sound of the other musical instrument. Synchronizing the image data and the sound data with each other includes synchronizing the image data with the sound data that has undergone the sound processing. In this embodiment, the performance sound of the percussion instrument is emphasized in the sound data. This ensures that the image data and the sound data are synchronized with each other more highly accurately than a configuration in which the performance sound indicated by the sound data also includes a substantial amount of performance sound of a musical instrument other than the percussion instrument.

The term “sound processing”, as used in the present disclosure, is intended to mean any processing of emphasizing performance sound of a percussion instrument relative to performance sound of a musical instrument other than the percussion instrument. An example of the “sound processing” is lowpass filter processing employing a low-pass filter with its cutoff frequency adjusted to the highest frequency within the percussion instrument's tonal range. Another example of the “sound processing” is sound source separation processing of separating performance sound of a percussion instrument from performance sound of a musical instrument other than the percussion instrument. It is to be noted that the performance sound of the musical instrument other than the percussion instrument may not necessarily be removed completely. That is, any processing is encompassed within the “sound processing” if the processing is to reduce (ideally, remove) the performance sound of the musical instrument other than the percussion instrument relative to the performance sound of the percussion instrument.

The performance analysis method according to a specific example (embodiment 6) of embodiment 4 or 5 further includes setting an adjustment value. The performance analysis method further includes, after synchronizing the image data and the sound data with each other, changing a position of one of the image data and the sound data on a time axis based on the adjustment value relative to a position of an other of the image data and the sound data. In this embodiment, the position of one of the image data and the sound data on the time axis relative to the position of the other of the image data and the sound data can be adjusted after the synchronization using the pulse data.

In a specific example (embodiment 7) of embodiment 6, setting the adjustment value includes setting the adjustment value based on an instruction from a user. In this embodiment, the adjustment value is set based on an instruction from the user. This ensures that the position on the time axis of one of the image data and the sound data is adjusted as intended by the user relative to the position of the other of the image data and the sound data.

In a specific example (embodiment 8) of embodiment 6, setting the adjustment value includes processing, using a trained model, input data that is based on the image data. The trained model has been trained to learn a relationship between learning input data and a learning adjustment value. The learning input data is based on an image of the percussion instrument. The learning adjustment value is for changing the position of one of the image data and the sound data on the time axis relative to the position of the other of the image data and the sound data. In this embodiment, the adjustment value is generated using a trained model, which has been subjected to machine learning. This ensures that a statistically appropriate adjustment value is generated for unknown input data based on an relationship between input data and adjustment values in a plurality of machine-learning training data. The input data includes may include image data itself generated by imaging a percussion instrument or a feature quantity calculated based on the image data. The feature quantity is an image feature quantity variable based on the proceed of a performance using a percussion instrument. The input data may also include a condition such as the type or size of the percussion instrument estimated from the image data.

The term “trained model”, as used in the present disclosure, is intended to mean a trained model that has been trained to learn, by machine learning, a relationship between input data and adjustment values. Examples of the “trained model” include various statistical estimation models such as a deep neural network (DNN), a hidden Markov model (H-MM), and a support vector machine (SVM).

The term “input data”, as used in the present disclosure, is intended to mean any data that is based on the image data. For example, the image data itself may be used as the input data. For another example, a feature quantity extracted from the image data may be used as the input data. Specifically, a feature quantity such as the size or type of the percussion instrument indicated by the image data may be input into the trained model as the input data. Another possible example is that the distance (imaging distance) between the percussion instrument and an imaging device (imager) that imaged the percussion instrument is input into the trained model as the input data.

A performance analysis method according to another embodiment (embodiment 9) of the present disclosure includes obtaining image data generated by imaging a percussion instrument. The performance analysis method also includes processing the image data to generate performance data indicating striking of the percussion instrument. The performance analysis method also includes, based on the performance data, generating pulse data indicating a pulse structure. In this embodiment, performance data is generated by processing the image data, and pulse data is generated based on the performance data. That is, the performance data and the pulse data, each serving as a chronological reference associated with striking of the percussion instrument (a performance using the percussion instrument), are generated based on the image data.

In a specific example (embodiment 10) of embodiment 9, generating the performance data includes processing, using a trained model, input data that is based on the image data. The trained has been trained to learn a relationship between learning performance data and training input data that is based on an image of the percussion instrument. The input data processed using the trained model includes at least one of image data indicating the image of the percussion instrument or a feature quantity of the image calculated based on the image data. The performance data includes data indicating a time point at which a sound of the percussion instrument is emitted. In this embodiment, statistically appropriate performance data is generated for unknown input data based on an relationship between input data and performance data in a plurality of machine-learning training data. The input data includes may include image data itself generated by imaging a percussion instrument or a feature quantity calculated based on the image data. The feature quantity is an image feature quantity variable based on the proceed of a performance using a percussion instrument.

A performance analysis method according to another embodiment (embodiment 11) of the present disclosure includes obtaining image data generated by imaging a percussion instrument, and processing the image data to generate pulse data indicating a pulse structure. In this embodiment, by processing the image data pulse data is generated. That is, the pulse data, which serves as a chronological reference associated with striking of the percussion instrument (a performance using the percussion instrument), is generated based on the image data.

In a specific example (embodiment 12) of embodiment 11, generating the pulse data includes processing, using a trained model, input data that is based on the image data. The trained has been trained to learn a relationship between learning pulse data and training input data that is based on an image of the percussion instrument. In this embodiment, statistically appropriate pulse data is generated for unknown input data based on an relationship between input data and pulse data in a plurality of machine-learning training data. The input data includes may include image data itself generated by imaging a percussion instrument or a feature quantity calculated based on the image data. The feature quantity is an image feature quantity variable based on the proceed of a performance using a percussion instrument.

In a specific example (embodiment 13) according to any one of embodiments 9 to 12, the input data processed using the trained model includes at least one of image data indicating the image of the percussion instrument or a feature quantity of the image calculated based on the image data. In a specific example (embodiment 14) according to any one of embodiments 9 to 13, the feature quantity of the image is, for example, a feature quantity related to movement of a feature point of the percussion instrument.

In a specific example (embodiment 15) according to any one of embodiments 9 to 14, the percussion instrument includes a vibration body and a striking body. The vibration body is vibratable by the striking of the percussion instrument. The striking body is used for the striking of the percussion instrument. An image indicated by the image data includes an image of the striking body. In this embodiment, the performance data or the pulse data is generated based on an image of the striking body. This eliminates the need for an image of the vibration body of the percussion instrument. Even in a case that the percussion instrument includes no vibration body (for example, in a case of an air drum), the performance data or the pulse data is generated.

The performance analysis method according to each of the embodiments exemplified above may be implemented as a performance analysis system. The performance analysis method according to each of the embodiments exemplified above may also be implemented as a program for causing a computer system to perform the performance analysis method.

As used herein, the term “comprise” and its variations are intended to mean open-ended terms, not excluding any other elements and/or components that are not recited herein. The same applies to the terms “include”, “have”, and their variations.

As used herein, a component suffixed with a term such as “member”, “portion”, “part”, “element”, “body”, and “structure” is intended to mean that there is a single such component or a plurality of such components.

As used herein, ordinal terms such as “first” and “second” are merely used for distinguishing purposes and there is no other intention (such as to connote a particular order) in using ordinal terms. For example, the mere use of “first element” does not connote the existence of “second element”; otherwise, the mere use of “second element” does not connote the existence of “first element”.

As used herein, approximating language such as “approximately”, “about”, and “substantially” may be applied to modify any quantitative representation that could permissibly vary without a significant change in the final result obtained. All of the quantitative representations recited in the present application shall be construed to be modified by approximating language such as “approximately”, “about”, and “substantially”.

As used herein, the phrase “at least one of A and B” is intended to be interpreted as “only A”, “only B”, or “both A and B”.

Obviously, numerous modifications and variations of the present disclosure are possible in light of the above teachings. It is therefore to be understood that within the scope of the appended claims, the present disclosure may be practiced otherwise than as specifically described herein.

What is claimed is:

1. A performance analysis method implemented by a computer system, the performance analysis method comprising:
obtaining image data generated by imaging a percussion instrument;
analyzing the image data to detect a change in the percussion instrument caused by striking of the percussion instrument;
based on the detected change, generating performance data indicating the striking of the percussion instrument; and
based on the performance data, generating pulse data indicating a pulse structure.

2. The performance analysis method according to claim 1, wherein
the percussion instrument comprises a vibration body vibratable by the striking of the percussion instrument, and
detecting the change in the percussion instrument comprises
from an image indicated by the image data, identifying a target region of the percussion instrument, the target region being where the vibration body exists, and
detecting a vibration of the vibration body based on a change in the image in the target region.

3. The performance analysis method according to claim 1, wherein
the percussion instrument comprises a striking body used for the striking of the percussion instrument, and
detecting the change in the percussion instrument comprises
identifying the striking body from an image indicated by the image data, and
based on a change in the image showing the striking body, detecting the striking of the percussion instrument struck by the striking body.

4. The performance analysis method according to claim 1, further comprising:
obtaining sound data indicating a performance sound; and
synchronizing the image data and the sound data with each other using the pulse data.

5. The performance analysis method according to claim 4, wherein
the performance sound indicated by the sound data comprises
a performance sound of the percussion instrument, and
a performance sound of an other musical instrument different from the percussion instrument,
the performance analysis method further comprises performing sound processing on the sound data, the sound processing comprising emphasizing the performance sound of the percussion instrument relative to the performance sound of the other musical instrument, and
synchronizing the image data and the sound data with each other comprises synchronizing the image data with the sound data that has undergone the sound processing.

6. The performance analysis method according to claim 4, further comprising:
setting an adjustment value; and
after synchronizing the image data and the sound data with each other, changing a position of one of the image data and the sound data on a time axis based on the adjustment value relative to a position of an other of the image data and the sound data.

7. The performance analysis method according to claim 6, wherein setting the adjustment value comprises setting the adjustment value based on an instruction from a user.

8. The performance analysis method according to claim 6, wherein setting the adjustment value comprises processing, using a trained model, input data that is based on the image data, the trained model having been trained to learn a relationship between learning input data and a learning adjustment value, the learning input data being based on an image of the percussion instrument, the learning adjustment value being for changing the position of one of the image data and the sound data on the time axis relative to the position of the other of the image data and the sound data.

9. A performance analysis method implemented by a computer system, the performance analysis method comprising:
obtaining image data generated by imaging a percussion instrument;
processing the image data to generate performance data indicating striking of the percussion instrument; and
based on the performance data, generating pulse data indicating a pulse structure.

10. The performance analysis method according to claim 9, wherein
generating the performance data comprises processing, using a trained model, input data that is based on the image data, the trained having been trained to learn a relationship between learning performance data and training input data that is based on an image of the percussion instrument,
the input data processed using the trained model comprises at least one of image data indicating the image of the percussion instrument or a feature quantity of the image calculated based on the image data, and
the performance data comprises data indicating a time point at which a sound of the percussion instrument is emitted.

11. A performance analysis method implemented by a computer system, the performance analysis method comprising:
obtaining image data generated by imaging a percussion instrument; and
processing the image data to generate pulse data indicating a pulse structure.

12. The performance analysis method according to claim 11, wherein generating the pulse data comprises processing, using a trained model, input data that is based on the image data, the trained having been trained to learn a relationship between learning pulse data and training input data that is based on an image of the percussion instrument.

13. The performance analysis method according to claim 12, wherein the input data processed using the trained model comprises at least one of image data indicating the image of the percussion instrument or a feature quantity of the image calculated based on the image data.

14. The performance analysis method according to claim 10, wherein the feature quantity of the image is a feature quantity related to movement of a feature point of the percussion instrument.

15. The performance analysis method according to claim 9, wherein
the percussion instrument comprises
a vibration body vibratable by the striking of the percussion instrument; and
a striking body used for the striking of the percussion instrument, and an image indicated by the image data includes an image of the striking body.

16. A performance analysis system comprising:
an image data obtainer configured to obtain image data generated by imaging a percussion instrument;
an analysis processor configured to analyze the image data to detect a change in the percussion instrument caused by striking of the percussion instrument;
a performance data generator configured to generate, based on the detected change, performance data indicating the striking of the percussion instrument; and
a pulse data generator configured to generate, based on the performance data, pulse data indicating a pulse structure.

17. A non-transitory computer-readable storage medium storing a program which, when executed by a computer system, causes the computer system to:
obtain image data generated by imaging a percussion instrument;
analyze the image data to detect a change in the percussion instrument caused by striking of the percussion instrument;
generate, based on the detected change, performance data indicating the striking of the percussion instrument; and
generate, based on the performance data, pulse data indicating a pulse structure.

18. The performance analysis method according to claim 2, wherein
the percussion instrument comprises a striking body used for the striking of the percussion instrument, and
detecting the change in the percussion instrument comprises
identifying the striking body from an image indicated by the image data, and
based on a change in the image showing the striking body, detecting the striking of the percussion instrument struck by the striking body.

19. The performance analysis method according to claim 2, further comprising:
obtaining sound data indicating a performance sound; and
synchronizing the image data and the sound data with each other using the pulse data.

20. The performance analysis method according to claim 3, further comprising:
obtaining sound data indicating a performance sound; and
synchronizing the image data and the sound data with each other using the pulse data.
